(19) United States
(12) Patent Application Publication
(10) Pub. No.: US 2026/0115664 A1
(43) Pub. Date: Apr. 30, 2026

(54) SYSTEM AND METHODS FOR CONCENTRATING DISSOLVED SOLIDS IN AN AQUEOUS SOLUTION

(71) Applicant: SAUDI WATER AUTHORITY, Riyadh (SA)

(72) Inventors: Sheng LI, Al-Khobar (SA); Sangho LEE, Al-Jubail (SA); Ahmed ALAMOUDI, Al-Jubail (SA); Eslam ALWAZNANI, Al-Jubail (SA); Ghulam MUSTAFA, Riyadh (SA)

(21) Appl. No.: 19/357,387

(22) Filed: Oct. 14, 2025

Related U.S. Application Data
(60) Provisional application No. 63/711,376, filed on Oct. 24, 2024.

(51) Int. Cl. B01D 61/02; B01D 69/12

(52) U.S. Cl. CPC B01D 61/029; B01D 61/025; B01D 61/0271; B01D 69/12; B01D 2257/80; B01D 2311/14; B01D 2313/243; B01D 2325/20

(57) ABSTRACT

System and process for concentrating dissolved solids in an aqueous solution. The system contains a first nanofiltration unit, a second nanofiltration unit in fluid communication with the first nanofiltration unit, and a reverse osmosis unit. Each nanofiltration unit may contain a plurality of nanofiltration membranes. The plurality of nanofiltration membranes may include a first nanofiltration membrane located upstream from a second nanofiltration unit where the first nanofiltration membrane has a higher salt rejection and higher water rejection rate than the second nanofiltration unit.

### CROSS-REFERENCE TO RELATED APPLICATIONS

This application claims the benefit of priority of U.S. Provisional Patent Application No. 63/711,376, filed Oct. 24, 2024, which is hereby incorporated by reference in its entirety.

### FIELD OF THE DISCLOSURE

This disclosure generally relates to a system for concentrating dissolved solids in an aqueous solution, and a process for using the system. The system contains at least two nanofiltration units and a reverse osmosis unit, such as an osmotic assisted reverse osmosis unit, where the reverse osmosis unit is positioned downstream of the at least two nanofiltration units.

### DESCRIPTION OF RELATED ART

Desalination is used to remove salts from saline water to produce water suitable for human consumption and irrigation. Brine is a byproduct from the desalination process. Increased use of desalination has led to production of large amounts of brine. The desalination brine byproduct is disposed primarily by dumping into the sea or injecting underground. These disposal methods are very expensive since they require costly pumping systems. Furthermore, care must be taken to prevent damage of the marine ecosystem, and contamination of ground fresh water from the disposed brine. Brine however has many industrial usage. For example, brine is used in food processing, cooking, de-icing, and heat transfer medium. Yet the brine byproduct from desalination has low salt concentration and needs to be concentrated prior to such usage. Current methods of brine concentrations are very energy intensive and have high capital expenditure (capex). Some brine concentration system includes big chilling systems which further increases the capex of the process.

### SUMMARY

A discovery has been made that provides a solution to at least one or more of the aforementioned problems associated with brine concentration. In one aspect, a hybrid nanofiltration and reverse osmosis system was developed. The hybrid system can concentrate the desalination brine byproduct in a two stage nanofiltration process and a reverse osmosis process to obtain concentrated brine. The desalination brine byproduct can have a concentration of 70,000 to 90,000 mg total dissolved solids (TDS) per liter. The two stage nanofiltration process can concentrate the TDS of the brine to a concentration of 100,000 to 140,000 mg/L. The reverse osmosis process can further concentrate the brine TDS to a concentration of 160,000 to 200,000 mg/L. The reverse osmosis system may be an osmotically assisted reverse osmosis (OARO) system. The nanofiltration process can be performed at a relatively low pressure such as at 30 to 40 bar, which is generally lower than the pressure required for reverse osmosis or other high pressure processes. Since in the method of the present disclosure the brine is partially concentrated using low pressure nanofiltration process, the process is relatively more energy efficient than a processes which uses primarily high pressure and/or high temperature processes for concentrating brine.

Some aspects of the disclosure are directed to a system for concentrating dissolved solids in an aqueous solution. The system can include a first nanofiltration unit, a second nanofiltration unit, and a reverse osmosis unit. In certain embodiments, the aqueous solution contains brine. In certain particular embodiments, the aqueous solution contains a brine that is produced as byproduct from desalination of saline water.

The first nanofiltration unit can contain a first nanofiltration membrane, a first feed inlet, a first concentrate outlet, and a first permeate outlet. The first feed inlet can be in fluid communication with an aqueous solution source. The first nanofiltration membrane can be in fluid communication with the first feed inlet, the first concentrate outlet, and the first permeate outlet. In certain embodiments, the first nanofiltration unit contains more than one nanofiltration membranes. In certain embodiments, a first of the more than one nanofiltration membranes of the first nanofiltration unit has a lower water permeability than that of a second of the more than one nanofiltration membranes of the first nanofiltration unit. In certain embodiments, the first of the more than one nanofiltration membranes of the first nanofiltration unit has a lower salt permeability than that of the second of the more than one nanofiltration membranes of the first nanofiltration unit. In certain embodiments, the first of the more than one nanofiltration membranes of the first nanofiltration unit has a lower water permeability and a lower salt permeability than that of the second of the more than one nanofiltration membranes of the first nanofiltration unit.

In certain embodiments, the first of the more than one nanofiltration membranes of the first nanofiltration unit has a salt permeability of 0.5 L/(m²·h) to 100 L/(m²·h), a water permeability of 0.05 L/(m²·h·bar) to 1.5 L/(m²·h·bar), or both. In certain embodiments, the second of the more than one nanofiltration membranes of the first nanofiltration unit has a salt permeability of greater than 100 L/(m²·h) to 400 L/(m²·h), a water permeability of greater than 1.5 L/(m²·h·bar) to 4 L/(m²·h·bar), or both. In certain embodiments, the first of the more than one nanofiltration membranes of the first nanofiltration unit has a salt permeability of at, greater than, less than, or between 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 L/(m²·h), or any range thereof. In certain embodiments, the first of the more than one nanofiltration membranes of the first nanofiltration unit has a water permeability of at, greater than, less than, or between 0.05, 0.06, 0.07, 0.08, 0.09, 0.1, 0.2, 0.3, 0.4, 0.5, 0.6, 0.7, 0.8, 0.9, 1, 1.1, 1.2, 1.3, 1.4, or 1.5 L/(m²·h·bar) or any range thereof. In certain embodiments, the second of the more than one nanofiltration membranes of the first nanofiltration unit has a salt permeability of at, greater than, less than, or between 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, or 400 L/(m²·h), or any range thereof. In certain embodiments, the second of the more than one nanofiltration membranes of the first nanofiltration unit has a water permeability of at, greater than, less than, or between 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, or 4 L/(m²·h·bar), or any range thereof.

In certain embodiments, the first of the more than one nanofiltration membranes of the first nanofiltration unit is in a fluid communication with the first feed inlet and a first inter nanofiltration unit outlet. In certain embodiments, the second of the more than one nanofiltration membranes of the first nanofiltration unit is in a fluid communication with the first inter nanofiltration unit outlet and the first concentrate outlet.

In certain embodiments, the first nanofiltration unit contains a plurality of the first of the more than one nanofiltration membranes of the first nanofiltration unit. In certain embodiments, the first nanofiltration unit contains a plurality of the second of the more than one nanofiltration membranes of the first nanofiltration unit. In some instances, the first nanofiltration unit contains more of the first of the more than one nanofiltration membranes than the second of the more than one nanofiltration membranes. In some instances, the first nanofiltration unit contains a ratio of the first of the more than one nanofiltration membranes to the second of the more than one nanofiltration membranes of 2:1 to 10:1, such as at, less than, greater than, or between, 2:1, 3:1, 4:1, 5:1, 6:1, 7:1, 8:1, 9:1, 10:1, or any range therein.

In certain embodiments, the first nanofiltration unit is configured to be operated at a pressure of 25 to 45 bar. In certain embodiments, the first nanofiltration unit is configured to be operated at a pressure of at, greater than, less than, or between 25, 26, 27, 28, 29, 30, 31, 32, 33, 34, 35, 36, 37, 38, 39, 40, 41, 42, 43, 44, or 45 bar, or any range thereof.

The second nanofiltration unit can contain a second nanofiltration membrane, a second feed inlet, a second concentrate outlet, and a second permeate outlet. The second feed inlet can be in fluid communication with the first concentrate outlet. In certain embodiments, the second permeate outlet is in fluid communication with the aqueous solution source and/or the first feed inlet. In certain embodiments, the second permeate outlet is in fluid communication with the aqueous solution source. In certain embodiments, the second permeate outlet is in fluid communication with the first feed inlet. The second nanofiltration membrane can be in fluid communication with the second feed inlet, the second concentrate outlet, and the second permeate outlet. In certain embodiments, the second nanofiltration membrane can contain more than one nanofiltration membranes. In certain embodiments, a first of the more than one nanofiltration membranes of the second nanofiltration unit has a lower water permeability than that of a second of the more than one nanofiltration membranes of the second nanofiltration unit. In certain embodiments, the first of the more than one nanofiltration membranes of the second nanofiltration unit has a lower salt permeability than that of the second of the more than one nanofiltration membranes of the second nanofiltration unit. In certain embodiments, the first of the more than one nanofiltration membranes of the second nanofiltration unit has a lower water permeability and a lower salt permeability than that of the second of the more than one nanofiltration membranes of the second nanofiltration unit.

In certain embodiments, the first of the more than one nanofiltration membranes of the second nanofiltration unit has a salt permeability of 0.5 L/(m²·h) to 100 L/(m²·h), a water permeability of 0.05 L/(m²·h·bar) to 1.5 L/(m²·h·bar), or both. In certain embodiments, the second of the more than one nanofiltration membranes of the second nanofiltration unit has a salt permeability of greater than 100 L/(m²·h) to 400 L/(m²·h), a water permeability of greater than 1.5 L/(m²·h·bar) to 4 L/(m²·h·bar), or both. In certain embodiments, the first of the more than one nanofiltration membranes of the second nanofiltration unit has a salt permeability of at, greater than, less than, or between 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 L/(m²·h), or any range thereof. In certain embodiments, the first of the more than one nanofiltration membranes of the second nanofiltration unit has a water permeability of at, greater than, less than, or between 0.05, 0.06, 0.07, 0.08, 0.09, 0.1, 0.2, 0.3, 0.4, 0.5, 0.6, 0.7, 0.8, 0.9, 1, 1.1, 1.2, 1.3, 1.4, or 1.5 L/(m²·h·bar) or any range thereof. In certain embodiments, the second of the more than one nanofiltration membranes of the second nanofiltration unit has a salt permeability of at, greater than, less than, or between 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, or 400 L/(m²·h), or any range thereof. In certain embodiments, the second of the more than one nanofiltration membranes of the second nanofiltration unit has a water permeability of at, greater than, less than, or between 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, or 4 L/(m²·h·bar), or any range thereof.

In certain embodiments, the first of the more than one nanofiltration membranes of the second nanofiltration unit is in a fluid communication with the second feed inlet and a second inter nanofiltration unit outlet. In certain embodiments, the second of the more than one nanofiltration membranes of the second nanofiltration unit is in a fluid communication with the second inter nanofiltration unit outlet and the second concentrate outlet.

In certain embodiments, the second nanofiltration unit contains a plurality of the first of the more than one nanofiltration membranes of the second nanofiltration unit. In certain embodiments, the second nanofiltration unit contains a plurality of the second of the more than one nanofiltration membranes of the second nanofiltration unit. In some instances, the second nanofiltration unit contains more of the first of the more than one nanofiltration membranes than the second of the more than one nanofiltration membranes. In some instances, the second nanofiltration unit contains a ratio of the first of the more than one nanofiltration membranes to the second of the more than one nanofiltration membranes of 2:1 to 10:1, such as at, less than, greater than, or between, 2:1, 3:1, 4:1, 5:1, 6:1, 7:1, 8:1, 9:1, 10:1, or any range therein.

In certain embodiments, the second nanofiltration unit is configured to be operated at a pressure of 25 to 45 bar. In certain embodiments, the second nanofiltration unit is configured to be operated at a pressure of at, greater than, less than, or between 25, 26, 27, 28, 29, 30, 31, 32, 33, 34, 35, 36, 37, 38, 39, 40, 41, 42, 43, 44, or 45 bar, or any range thereof.

The reverse osmosis unit can contain a reverse osmosis membrane, a reverse osmosis feed inlet, a reverse osmosis concentrate outlet, and a reverse osmosis permeate outlet. The reverse osmosis membrane can be in fluid communication with the reverse osmosis feed inlet, the reverse osmosis concentrate outlet, and the reverse osmosis permeate outlet. The reverse osmosis feed inlet can be in fluid communication with the second concentrate outlet. In certain embodiments, the reverse osmosis unit can be an osmotically assisted reverse osmosis unit. In certain embodiments, the reverse osmosis membrane is a high rejection osmotically assisted reverse osmosis membrane.

In certain embodiments, the reverse osmosis unit is configured to be operated at a pressure of 65 to 85 bar. In certain embodiments, the reverse osmosis unit is configured to be operated at a pressure of at, greater than, less than, or between 65, 66, 67, 68, 69, 70, 71, 72, 73, 74, 75, 76, 77, 78, 79, 80, 81, 82, 83, 84, or 85 bar, or any range thereof. In certain embodiments, the system comprises a high pressure pump in fluid communication with the second concentrate outlet and the reverse osmosis feed inlet.

In certain embodiments, the reverse osmosis membrane, such as the high rejection osmotically assisted reverse osmosis membrane, can have a water permeability of 0.05 to 3 L/(m²·h·bar), a salt permeability of 0.5 to 30 L/(m²·h), or both. In certain embodiments, the reverse osmosis membrane has a salt permeability of at, greater than, less than, or between 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 L/(m²·h), or any range thereof. In certain embodiments, the reverse osmosis membrane has a water permeability of at, greater than, less than, or between 0.05, 0.06, 0.07, 0.08, 0.09, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, or 3 L/(m²·h·bar) or any range thereof.

In certain embodiments, the aqueous solution source may be a desalination system. In certain embodiments, the desalination system may contain a dual-media filtration (DMF) unit, cartridge filtration (CF) unit, pre-nanofiltration unit, and/or sea water reverse osmosis (SWRO) unit. The DMF unit may contain a dual-media filtration membrane, and may be in fluid communication with a saline water source, and the CF unit. The CF unit may contain a cartridge filtration membrane, and may be in fluid communication with the DMF unit and the pre-nanofiltration unit. The pre-nanofiltration unit may contain a nanofiltration membrane, and may be in fluid communication with the CF unit and the SWRO unit. The SWRO unit may contain a reverse osmosis desalination membrane, and may be in fluid communication with the pre-nanofiltration unit and the first feed inlet. The SWRO unit may produce brine as retentate, and the first feed inlet may be fluidly connected to a retentate brine outlet of the SWRO unit. In certain embodiments, the system includes the desalination system. In some aspects, the system does not include the desalination system.

Some aspects of the disclosure are directed to a method for concentrating dissolved solids in an aqueous solution. In some aspects, the method uses a system described herein. The method can include steps (i), (ii), and/or (iii). In step (i), a brine solution can be flowed through the first feed inlet to separate ions from the brine solution to form a first concentrate and a first permeate. In step (ii), the first concentrate can be flowed through the second feed inlet to separate ions from the first concentrate to form a second concentrate and a second permeate. In step (iii), the second concentrate can be flowed through the reverse osmosis feed inlet to separate ions from the second concentrate to form a reverse osmosis concentrate and a reverse osmosis permeate.

In step (i), separating ions from the brine solution can include contacting the brine solution with the first nanofiltration membrane to produce the first concentrate and the first permeate. In certain embodiments, the first nanofiltration membrane contains the first of the more than one nanofiltration membranes of the first nanofiltration unit, and the second of the more than one nanofiltration membranes of the first nanofiltration unit, and separating ions from the brine solution includes contacting the brine solution with the first of the more than one nanofiltration membranes of the first nanofiltration unit to produce a first intermediate concentrate, and contacting the first intermediate concentrate with the second of the more than one nanofiltration membranes of the first nanofiltration unit to produce the first concentrate. The first intermediate concentrate can be flowed through the first inter nanofiltration unit outlet, and can be contacted with the second of the more than one nanofiltration membranes of the first nanofiltration unit. The first concentrate can contain a retentate from nanofiltration of the brine solution using the first nanofiltration membrane, or a retentate from nanofiltration of the first intermediate concentrate using the second of the more than one nanofiltration membranes of the first nanofiltration unit. The first intermediate concentrate can contain a retentate from nanofiltration of the brine solution using the first of the more than one nanofiltration membranes of the first nanofiltration unit.

Separating ions from the brine solution in step (i) can be performed at a pressure of 25 to 45 bar. In certain embodiments, step (i) can be performed at a pressure of at, greater than, less than, or between 25, 26, 27, 28, 29, 30, 31, 32, 33, 34, 35, 36, 37, 38, 39, 40, 41, 42, 43, 44, or 45 bar, or any range thereof. In certain embodiments, the brine solution is flowed through the first feed inlet at a flow rate of 1 m³/h to 25 m³/h. In certain embodiments, brine solution is flowed through the first feed inlet at a flow rate of at, greater than, less than, or between 1, 2, 3, 4, 5, 6, 7, 8, 9, 10, 11, 12, 13, 14, 15, 16, 17, 18, 19, 20, 21, 22, 23, 24, or 25 m³/h, or any range thereof. In certain embodiments, the brine solution contains 70,000 to 90,000 mg/L total dissolved solids (TDS). In certain embodiments, the brine solution contains at, greater than, less than, or between 70,000, 71,000, 72,000, 73,000, 74,000, 75,000, 76,000, 77,000, 78,000, 79,000, 80,000, 81,000, 82,000, 83,000, 84,000, 85,000, 86,000, 87,000, 88,000, 89,000, or 90,000 mg/L total dissolved solids (TDS), or any range thereof.

In step (ii), separating ions from the first concentrate can include contacting the first concentrate with the second nanofiltration membrane to produce the second concentrate and second permeate. In certain embodiments, the second nanofiltration membrane contains the first of the more than one nanofiltration membranes of the second nanofiltration unit, and the second of the more than one nanofiltration membranes of the second nanofiltration unit, and separating the ions from the first concentrate includes contacting the first concentrate with the first of the more than one nanofiltration membranes of the second nanofiltration unit to produce a second intermediate concentrate, and contacting the second intermediate concentrate with the second of the more than one nanofiltration membranes of the second nanofiltration unit to produce the second concentrate. The second intermediate concentrate can be flowed through the second inter nanofiltration unit outlet, and contacted with the second of the more than one nanofiltration membranes of the second nanofiltration unit. The second concentrate can contain a retentate from nanofiltration of the first concentrate using the second nanofiltration membrane, or a retentate from nanofiltration of the second intermediate concentrate using the second of the more than one nanofiltration membranes of the second nanofiltration unit. The second intermediate concentrate can contain a retentate from nanofiltration of the first concentrate using the first of the more than one nanofiltration membranes of the second nanofiltration unit.

Separating ions from the first concentrate in step (ii) can be performed at a pressure of 25 to 45 bar. In certain embodiments, step (ii) can be performed at a pressure of at, greater than, less than, or between 25, 26, 27, 28, 29, 30, 31, 32, 33, 34, 35, 36, 37, 38, 39, 40, 41, 42, 43, 44, or 45 bar, or any range thereof. The first concentrate can be flowed through the second feed inlet into the second nanofiltration unit at a flow rate of 1 m³/h to 25 m³/h. In certain embodiments, first concentrate is flowed through the second feed inlet into the second nanofiltration unit at a flow rate of at, greater than, less than, or between 1, 2, 3, 4, 5, 6, 7, 8, 9, 10, 11, 12, 13, 14, 15, 16, 17, 18, 19, 20, 21, 22, 23, 24, or 25 m³/h, or any range thereof, such as 2 to 7 m³/h. In certain embodiments, the second concentrate contains 100,000 to 140,000 TDS. In certain embodiments, the second concentrate contains at, greater than, less than, or between 100,000, 110,000, 120,000, 130,000, 140,000 mg/L total dissolved solids (TDS), or any range thereof. In some instances, the first concentrate flowed through the second feed inlet is equal to, greater than, less than, or between 35, 40, 45, 50, 55, 60, or 65% by volume, or any range thereof, compared to the volume of the brine solution flowed through the first feed inlet.

In step (iii), separating ions from the second concentrate can include contacting the second concentrate with the reverse osmosis membrane, such as the high rejection osmotically assisted reverse osmosis membrane, to produce the reverse osmosis concentrate and reverse osmosis permeate. The reverse osmosis concentrate can contain a retentate from osmotically assisted reverse osmosis of the second concentrate using the reverse osmosis membrane, such as the high rejection osmotically assisted reverse osmosis membrane.

Separating ions from the second concentrate in step (iii) can be performed at a pressure of 65 to 85 bar. In certain embodiments, separating ions from the second concentrate in step (iii) can be performed at a pressure of at, greater than, less than, or between 65, 66, 67, 68, 69, 70, 71, 72, 73, 74, 75, 76, 77, 78, 79, 80, 81, 82, 83, 84, or 85 bar, or any range thereof. The second concentrate can be flowed through the reverse osmosis feed inlet into the reverse osmosis unit at a flow rate of 0.5 m³/h to 10 m³/h. In certain embodiments, second concentrate is flowed through the reverse osmosis feed inlet into the reverse osmosis unit at a flow rate of at, greater than, less than, or between 0.5, 0.6, 0.7, 0.8, 0.9, 1, 2, 3, 4, 5, 6, 7, 8, 9, or 10 m³/h, or any range thereof. In certain embodiments, the reverse osmosis concentrate is a concentrated brine solution containing 160,000 to 200,000 TDS. In certain embodiments, the reverse osmosis concentrate contains at, greater than, less than, or between 160,000, 170,000, 180,000, 190,000, or 200,000 mg/L total dissolved solids (TDS), or any range thereof.

In certain embodiments, the system contains the high pressure pump in fluid communication with the second concentrate outlet and the reverse osmosis feed inlet, and the second concentrate is pumped into the reverse osmosis unit using the high pressure pump. The reverse osmosis concentrate can be produced at a flow rate of 0.1 m³/h to 8 m³/h. In certain embodiments, reverse osmosis concentrate is produced at a flow rate of at, greater than, less than, or between 0.1, 0.2, 0.3, 0.4, 0.5, 0.6, 0.7, 0.8, 0.9, 1, 2, 3, 4, 5, 6, 7, or 8 m³/h, or any range thereof.

In certain embodiments, the brine solution contains a retentate from the desalination system, such a retentate from the SWRO unit. The desalination retentate, such as the SWRO unit retentate can be formed by desalination of saline water using the desalination system. In certain embodiments, the method includes the desalination of the saline water using the desalination system. In certain embodiments, the second permeate is recycled back to the first nanofiltration unit, and the brine solution comprises the retentate from the desalination system, such as the retentate from the SWRO unit, and the second permeate.

The following includes definitions of various terms and phrases used throughout this specification.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component. The term “ppm” refer to parts per million by weight, based on the total weight, of material that includes the component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The covering of the present invention can “comprise,” “consist(s) essentially of,” or “consist of” particular ingredients, components, compositions, etc. disclosed throughout the specification. In one aspect of the present invention, and with reference to the transitional phrase “consist(s) essentially of” or “consisting essentially of,” a basic and novel characteristic of the present invention can include system and process for concentrating dissolved solids in an aqueous solution using a first nanofiltration membrane, a second nanofiltration membrane, and a reverse osmosis membrane.

Other objects, features and advantages of the present invention will become apparent from the following detailed description and examples. It should be understood, however, that the detailed description and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings. While the invention is susceptible to various modifications and alternative forms, specific embodiments thereof are shown by way of example in the drawings. The drawings may not be to scale.

FIG. 1: Schematic of a system for concentrating dissolved solids in an aqueous solution according to an example of the present disclosure is shown.

FIG. 2: Schematic of a system for concentrating dissolved solids in an aqueous solution according to another example of the present disclosure is shown.

FIG. 3: Schematic of a system for concentrating dissolved solids in an aqueous solution according to another example of the present disclosure is shown.

FIG. 4: Schematic of a system for concentrating dissolved solids in an aqueous solution according to another example of the present disclosure is shown.

FIG. 5: Schematic of a desalination system according to an example of the present disclosure is shown.

FIG. 6: A flow chart of the method steps employed for a method for concentrating dissolved solids in an aqueous solution using the system shown in FIGS. 1-3.

FIG. 7: A flow chart of the method steps employed for a method for concentrating dissolved solids in an aqueous solution using the system shown in FIG. 4.

### DETAILED DESCRIPTION

A discovery has been made that provides a system and process for concentrating brine. The system includes a hybrid nanofiltration reverse osmosis system. The hybrid system can concentrate a brine solution in a two stage nanofiltration process followed by a reverse osmosis process. The reverse osmosis process can in some aspects be an osmotically assisted reverse osmosis (OARO) system. The brine solution can be a byproduct of desalination of saline water. The desalination brine byproduct can have a concentration of 70,000 to 90,000 mg/L TDS. The two stage nanofiltration process can concentrate the desalination brine byproduct at a pressure of 30 to 40 bar to produce a retentate having a concentration of 100,000 to 140,000 mg/L TDS. The reverse osmosis process can further concentrate the retentate from the two stage nanofiltration process at a pressure of 70 to 85 bar to produce a concentrated brine having a concentration of 160,000 to 200,0000 mg/L TDS. Each stage of the two stage nanofiltration process can contain a high rejection nanofiltration membrane and a low rejection nanofiltration membrane. Water permeability of the high rejection nanofiltration membrane can be lower that the water permeability of the low rejection nanofiltration membrane. Salt permeability of the high rejection nanofiltration membrane can be lower than the salt permeability of the low rejection nanofiltration membrane.

These and other non-limiting aspects of the present disclosure are discussed in further detail in the following sections.

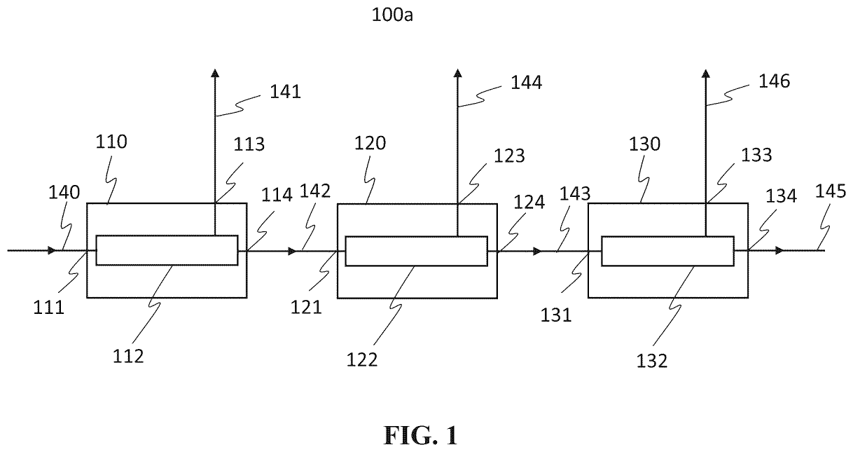

Referring to FIG. 1, a schematic of a system, 100a, for concentrating dissolved solids in an aqueous solution according to an example of the present disclosure is shown. The system 100 includes a first nanofiltration unit 110, a second nanofiltration unit 120, and a reverse osmosis unit 130.

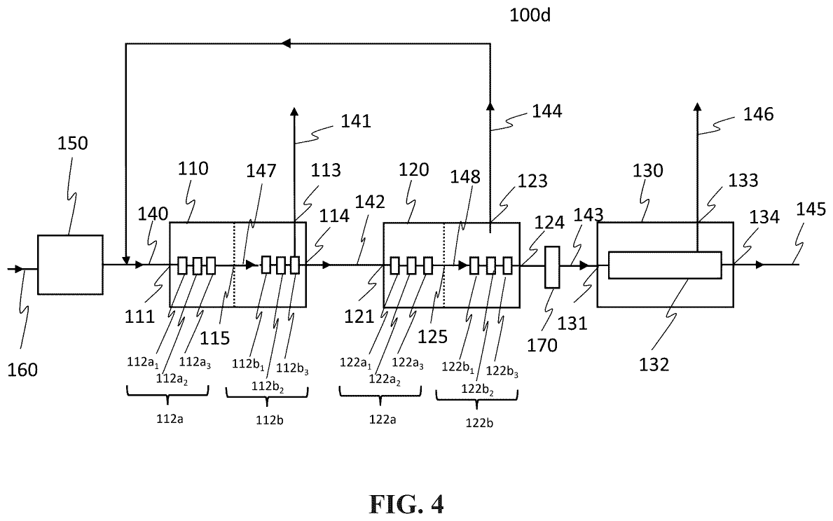

The first nanofiltration unit 110 in system 100a can contain a first nanofiltration membrane 112, a first feed inlet 111, a first concentrate outlet 114, and a first permeate outlet 113. The first feed inlet 111 can be in a fluid communication with an aqueous solution source (shown in FIG. 4). The first nanofiltration membrane 112 can be in a fluid communication with the first feed inlet 111, the first concentrate outlet 114, and the first permeate outlet 113. An aqueous solution 140 from the aqueous solution source (shown in FIG. 4) can be flowed through the first feed inlet 111 and can be contacted with the first nanofiltration membrane 112 to separate ions from the aqueous solution 140 and form a first concentrate 142 and a first permeate 141. The first concentrate 142 can contain a retentate, and the first permeate 141 can contain a permeate from nanofiltration of the aqueous solution 140 using the first nanofiltration membrane 112. The first concentrate 142 can be flowed out of the first nanofiltration unit 110 through the first concentrate outlet 114, and the first permeate 141 can be flowed out of the first nanofiltration unit 110 through the first permeate outlet 113.

The second nanofiltration unit 120, in system 100a, can contain a second nanofiltration membrane 122, a second feed inlet 121, a second concentrate outlet 124, and a second permeate outlet 123. The second feed inlet 121 can be in a fluid communication with the first concentrate outlet 114. The second nanofiltration membrane 122 can be in a fluid communication with the second feed inlet 121, the second concentrate outlet 124, and the second permeate outlet 123. The first concentrate 142 can be flowed through the second feed inlet 121 and can be contacted with the second nanofiltration membrane 122 to separate ions from the first concentrate 142 and form a second concentrate 143 and a second permeate 144. The second concentrate 143 can contain a retentate, and the second permeate 144 can contain a permeate from nanofiltration of the first concentrate 142 using the second nanofiltration membrane 122. The second concentrate 143 can be flowed out of the second nanofiltration unit 120 through the second concentrate outlet 124, and the second permeate 144 can be flowed out of the second nanofiltration unit 120 through the second permeate outlet 123.

The reverse osmosis unit 130, in system 100a, can contain a reverse osmosis membrane 132, a reverse osmosis feed inlet 131, a reverse osmosis concentrate outlet 134, and a reverse osmosis permeate outlet 133. The reverse osmosis feed inlet 131 can be in a fluid communication with the second concentrate outlet 124. The reverse osmosis membrane 132 can be in a fluid communication with the reverse osmosis feed inlet 131, the reverse concentrate outlet 134, and the reverse permeate outlet 133. The second concentrate 143 can be flowed through the reverse osmosis feed inlet 131 and can be contacted with the reverse osmosis membrane 132 to separate ions from the second concentrate 143 and form a reverse osmosis concentrate 145 and a reverse osmosis permeate 146. The reverse osmosis concentrate 145 can contain a retentate, and the reverse osmosis permeate 146 can contain a permeate from reverse osmosis, such as osmotically assisted reverse osmosis of the second concentrate 143 using the reverse osmosis membrane 132. If the reverse osmosis unit is an osmotically assisted reverse osmosis unit, then the reverse osmosis unit 130 would additionally contain a draw solution inlet (not shown) that is in fluid communication with the reverse osmosis permeate outlet 133, a draw solution (not shown) can be flowed through the draw solution inlet, contact the reverse osmosis membrane 132, draw water from the second concentrate 143 through the reverse osmosis membrane 132, and be flowed out of the reverse osmosis unit 130 through the reverse osmosis permeate outlet 133. The reverse osmosis concentrate 145 can be flowed out of the reverse osmosis unit 130 through the reverse osmosis concentrate outlet 134, and the reverse osmosis permeate 146 can be flowed out of the reverse osmosis unit 130 through the reverse osmosis permeate outlet 133.

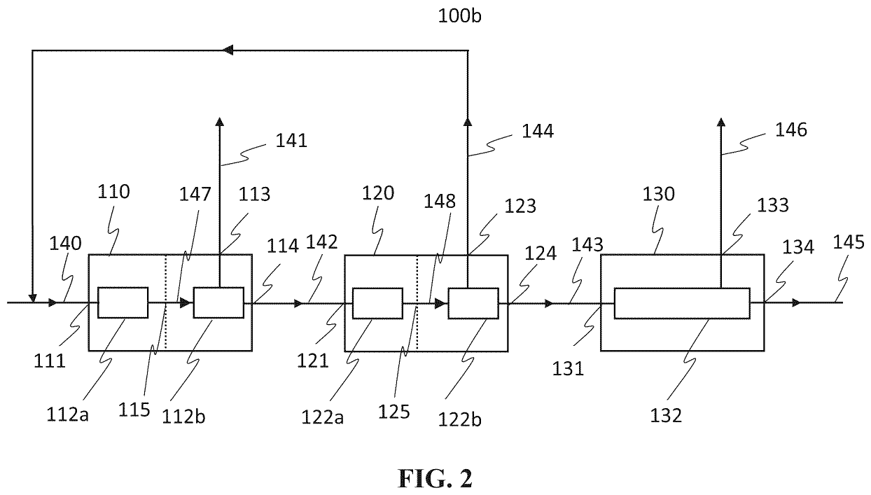

Referring to FIG. 2, a schematic of a system, 100b, for concentrating dissolved solids in an aqueous solution according to an example of the present disclosure is shown. The system 100b includes a first nanofiltration unit 110, a second nanofiltration unit 120, and a reverse osmosis unit 130.

The first nanofiltration unit 110 of the system 100b can contain a first feed inlet 111, a first concentrate outlet 114, a first permeate outlet 113, a first inter nanofiltration unit outlet 115, and more than one first nanofiltration membranes 112a and 112b. The first feed inlet 111 can be in a fluid communication with an aqueous solution source (shown in FIG. 4). The more than one first nanofiltration membranes can contain a first membrane 112a, and a second membrane 112b. The nanofiltration membrane 112a can be in a fluid communication with the first feed inlet 111, and the first inter nanofiltration unit outlet 115. The nanofiltration membrane 112b can be in a fluid communication with the first inter nanofiltration unit outlet 115, the first concentrate outlet 114, and the first permeate outlet 113. An aqueous solution 140 can be flowed through the first feed inlet 111 and can be contacted with the nanofiltration membrane 112a to separate ions from the aqueous solution 140 and form a first intermediate concentrate 147. The first intermediate concentrate 147 can contain a retentate from nanofiltration of the aqueous solution 140 using the nanofiltration membrane 112a. The first intermediate concentrate 147 can be flowed through the first inter nanofiltration unit outlet 115 and can be contacted with the nanofiltration membrane 112b to separate ions from the first intermediate concentrate and form a first concentrate 142, and a first permeate 141. The first concentrate 142 can contain a retentate, and the first permeate 141 can contain a permeate from nanofiltration of the first intermediate concentrate 147 using the nanofiltration membrane 112b. The first concentrate 142 can be flowed out of the first nanofiltration unit 110 through the first concentrate outlet 114, and the first permeate 141 can be flowed out of the first nanofiltration unit 110 through the first permeate outlet 113.

The second nanofiltration unit 120 of the system 100b can contain a second feed inlet 121, a second concentrate outlet 124, a second permeate outlet 123, a second inter nanofiltration unit outlet 125, and more than one second nanofiltration membranes 122a and 122b. The more than one second nanofiltration membranes contain a first membrane 122a, and a second membrane 122b. The nanofiltration membrane 122a can be in a fluid communication with the second feed inlet 121, and the second inter nanofiltration unit outlet 125. The nanofiltration membrane 122b can be in a fluid communication with the second inter nanofiltration unit outlet 125, the second concentrate outlet 124, and the second permeate outlet 123. The first concentrate 142 can be flowed through the second feed inlet 121 and can be contacted with the nanofiltration membrane 122a to separate ions from the first concentrate 142 and form a second intermediate concentrate 148. The second intermediate concentrate 148 can contain a retentate from nanofiltration of the first concentrate 142 using the nanofiltration membrane 122a. The second intermediate concentrate 148 can be flowed through the second inter nanofiltration unit outlet 125 and can be contacted with the nanofiltration membrane 122b to separate ions from the second intermediate concentrate 148 and form a second concentrate 143, and a second permeate 144. The second concentrate 143 can contain a retentate, and the second permeate 144 can contain a permeate from nanofiltration of the second intermediate concentrate 148 using the nanofiltration membrane 122b. The second concentrate 143 can be flowed out of the second nanofiltration unit 120 through the second concentrate outlet 124, and the second permeate 144 can be flowed out of the second nanofiltration unit 120 through the second permeate outlet 123. The second permeate outlet 123 can be in a fluid communication with the first feed inlet 111. The second permeate 144 can be mixed with aqueous solution 140 and contacted with the membrane 112a.

The reverse osmosis unit 130 of the system 100b can have the same configuration and process of operation as that described for the reverse osmosis unit of the system 100a.

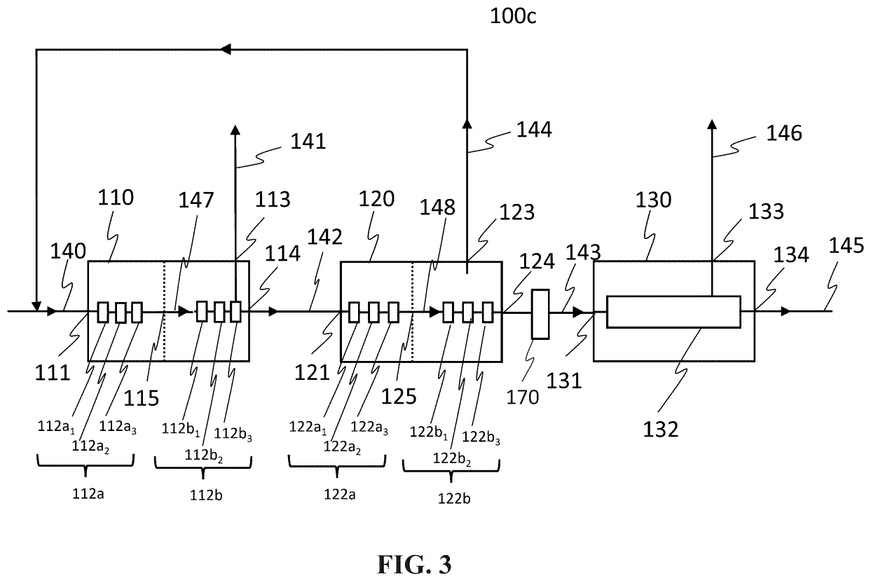

Referring to FIG. 3, a schematic of a system 100c for concentrating dissolved solids in an aqueous solution according to an example of the present disclosure is shown. The system 100c contains a plurality of the first of the more than one first nanofiltration membranes 112a, a plurality of the second of the more than one first nanofiltration membranes 112b, a plurality of the first of the more than one second nanofiltration membranes 122a, and a plurality of the second of the more than one second nanofiltration membranes 122b. The plurality of the nanofiltration membranes 112a can be fluidly connected in series, and the aqueous solution 140 can be nano filtered using the plurality of the nanofiltration membranes 112a to produce the first intermediate concentrate 147. The plurality of the nanofiltration membranes 112b can be fluidly connected in series, and the first intermediate concentrate 147 can be nano filtered using the plurality of the nanofiltration membranes 112b to produce the first concentrate 142, and first permeate 141. The plurality of the nanofiltration membranes 122a can be fluidly connected in series, and the first concentrate 142 can be nano filtered using the plurality of the nanofiltration membranes 122a to produce the second intermediate concentrate 148. The plurality of the nanofiltration membranes 122b can be fluidly connected in series, and the second intermediate concentrate 148 can be nano filtered using the plurality of the nanofiltration membranes 122b to produce the second concentrate 143, and second permeate 144. Although, three first of the more than one first nanofiltration membranes 112a₁, 112a₂, 112a₃ are shown in FIG. 3, any suitable number, one or more, of the first of the more than one first nanofiltration membranes 112a can be used. Although, three second of the more than one first nanofiltration membranes 112b₁, 112b₂, 112b₃ are shown in FIG. 3, any suitable number, one or more, of the second of the more than one first nanofiltration membranes 112b can be used. Although, three first of the more than one second nanofiltration membranes 122a₁, 122a₂, 122a₃ is shown in FIG. 3, any suitable number, one or more, of the first of the more than one second nanofiltration membranes 122a can be used. Although, three second of the more than one second nanofiltration membranes 122b₁, 122b₂, 122b₃ are shown in FIG. 3, any suitable number, one or more, of the second of the more than one second nanofiltration membranes 122b can be used. The system 100c can include a high pressure pump 170 fluidly connected to the second concentrate outlet 124 and the reverse osmosis feed inlet 131. The second concentrate 143 can be pumped into the reverse osmosis unit 130 using the high pressure pump 170. The other components of the system 100c, shown in FIG. 3, can be configured and operated in the manner described for system 100b.

Referring to FIG. 4, a schematic of a system 100d for concentrating dissolved solids in an aqueous solution according to an example of the present disclosure is shown. The system 100d contains a desalination system 150, a first nanofiltration unit 110, a second nanofiltration unit 120, and a reverse osmosis unit 130, and an optional high pressure pump 170. The desalination system 150 can be fluidly connected to the first nanofiltration unit 110. A saline solution 160 can be desalinated using the desalination system 150, and the aqueous solution 140 can contain a retentate from the desalination process. The first nanofiltration unit 110, second nanofiltration unit 120, and reverse osmosis unit 130, and an optional high pressure pump 170 of the system 100d, can be configured and operated in the manner described for system 100c.

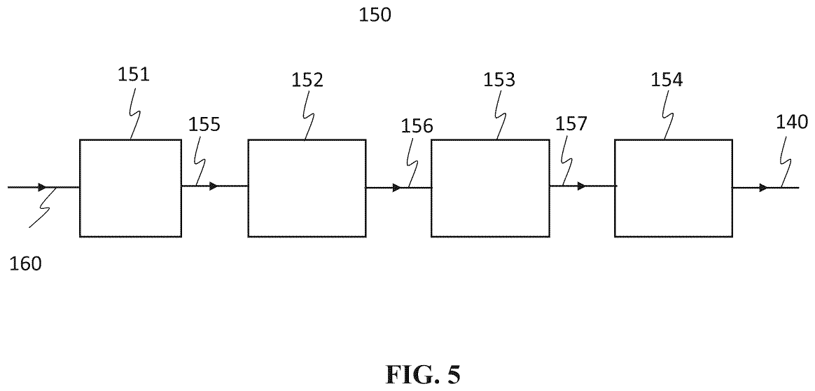

Referring to FIG. 5, the desalination system 150 of FIG. 4 can contain a dual-media filtration (DMF) unit 151, cartridge filtration (CF) unit 152, pre-nanofiltration unit 153, and sea water reverse osmosis (SWRO) unit 154, fluidly connected in series. The DMF unit 151 can contain a dual-media filtration membrane (not shown), the CF unit 152 can contain a cartridge filtration membrane (not shown), the pre-nanofiltration unit 153 can contain a nanofiltration membrane (not shown), and the SWRO unit 154 can contain a reverse osmosis membrane (not shown). The saline solution 160 can be fed to the DMF unit 151. In the DMF unit the saline solution 160 can be filtered and a stream 155 containing the permeate from the filtration can be fed to the CF unit 152. In the CF unit 152 the stream 155 can be filtered and a stream 156 containing the permeate from the filtration can be fed to the pre-nanofiltration unit 153. In the pre-nanofiltration unit 153 the stream 156 can be filtered and a stream 157 containing the permeate from the filtration can be fed to the SWRO unit 154. In the SWRO unit 154 the stream 157 can be filtered and the aqueous solution 140 can contain a retentate from the filtration process.

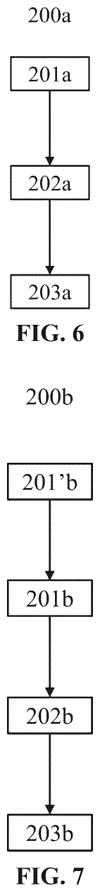

Referring to FIG. 6, a flow chart of the method steps employed for a method 200a for concentrating dissolved solids in an aqueous solution using the system 100a-c is shown. The method 200a can include steps 201a, 202a, and 203a. In the step 201a, the aqueous solution 140 can be flowed through the first feed inlet 111 to separate ions from the aqueous solution 140 to form the first concentrate 142 and the first permeate 141. The step 201a can be performed in the first nanofiltration unit 110, of the system 100a-c. In step 202a, the first concentrate 142 can be flowed through the second feed inlet 121 to separate ions from the first concentrate 142 to form a second concentrate 143 and a second permeate 144. The step 202a can be performed in the second nanofiltration unit 120, of the system 100a-c. In step 203a, the second concentrate 143 can be flowed through the reverse osmosis feed inlet 131 to separate ions from the second concentrate 143 to form a reverse osmosis concentrate 145 and a reverse osmosis permeate 146. The step 203a can be performed in the reverse osmosis unit 130, of the system 100a-c.

Referring to FIG. 7, a flow chart of the method steps employed for a method 200b for concentrating dissolved solids in an aqueous solution using the system 100d shown. The method 200b can include steps 201′b, 201b, 202b, and 203b. In step 201′b, the saline solution 160 can be desalinated using the desalination system 150 of system 100d to obtain the aqueous solution 140. In the step 201b, the aqueous solution 140 can be flowed through the first feed inlet 111 to separate ions from the aqueous solution 140 to form the first concentrate 142 and the first permeate 141. The step 201b can be performed in the first nanofiltration unit 110, of the system 100d. In step 202b, the first concentrate 142 can be flowed through the second feed inlet 121 to separate ions from the first concentrate 142 to form a second concentrate 143 and a second permeate 144. The step 202b can be performed in the second nanofiltration unit 120, of the system 100d. In step 203b, the second concentrate 143 can be flowed through the reverse osmosis feed inlet 131 to separate ions from the second concentrate 143 to form a reverse osmosis concentrate 145 and a reverse osmosis permeate 146. The step 203b can be performed in the reverse osmosis unit 130, of the system 100d.

The nanofiltration membrane 112a can have a lower salt permeability than the salt permeability of the nanofiltration membrane 112b. The nanofiltration membrane 122a can have a lower salt permeability than the salt permeability of the nanofiltration membrane 122b. In certain embodiments, the nanofiltration membrane 112a and/or 122a has a salt permeability of 0.5 to 100 L/(m²·h). In certain embodiments, the nanofiltration membrane 112a and/or 122a has a salt permeability of 0.5, 1, 1.5, 2, 2.5, 3, 3.5, 4, 4.5, 5, 5.5, 5, 6.5, 7, 7.5, 8, 8.5, 9, 10, 20, 30, 40, 50, 60, 70, 80, 90, or 100 L/(m²·h) or any range or value therebetween. In certain embodiments, the nanofiltration membrane 112a and/or 122a has a salt permeability of 0.5 to 80 L/(m²·h); 0.5 to 60 L/(m²·h); 0.5 to 40 L/(m²·h); 0.5 to 20 L/(m²·h); 0.5 to 10 L/(m²·h); 0.5 to 8 L/(m²·h); 0.5 to 6 L/(m²·h); 0.5 to 5 L/(m²·h); 0.5 to 4 L/(m²·h); 1 to 100 L/(m²·h); 1 to 80 L/(m²·h); 1 to 60 L/(m²·h); 1 to 40 L/(m²·h); 1 to 20 L/(m²·h); 1 to 10 L/(m²·h); 1 to 8 L/(m²·h); 1 to 6 L/(m²·h); 1 to 5 L/(m²·h); 1 to 4 L/(m²·h); 2 to 100 L/(m²·h); 2 to 80 L/(m²·h); 2 to 60 L/(m²·h); 2 to 40 L/(m²·h); 2 to 20 L/(m²·h); 2 to 10 L/(m²·h); 2 to 8 L/(m²·h); 2 to 6 L/(m²·h); 2 to 5 L/(m²·h); 2 to 4 L/(m²·h); 3 to 100 L/(m²·h); 3 to 80 L/(m²·h); 3 to 60 L/(m²·h); 3 to 40 L/(m²·h); 3 to 20 L/(m²·h); 3 to 10 L/(m²·h); 3 to 8 L/(m²·h); 3 to 6 L/(m²·h); 3 to 5 L/(m²·h); or 3 to 4 L/(m²·h). The salt permeability of the different nanofiltration membranes of the plurality of the nanofiltration membranes 112a and/or 122a in system 100c and 100d can be the same or different. As an illustrative non limiting example the salt permeability of 112a₁, 112a₂, and 112a₃ (in the system 100c and 100d) and/or 122a₁, 122a₂, and 122a₃ (in the system 100c and 100d) are the same and are in the range 0.5 to 100 L/(m²·h). In another illustrative non limiting example, in the system 100c and 100d the salt permeability of 112a₁ is the same as that of 112a₂, but is different from that of 112a₃, and/or the salt permeability of 122a₁ is the same as that of 122a₂, but is different from that of 122a₃, where the salt permeability of the membranes 112a₁, 112a2, 112a3, 122a₁, 122a₂, and 122a₃ all are in the range 0.5 to 100 L/(m²·h). In another illustrative non limiting example, in the system 100c and 100d the salt permeability of 112a₁, 112a₂, and 112a₃ are different and/or salt permeability of 122a₁, 122a₂, and 122a₃ are different, where the salt permeability of the membranes 112a₁, 112a₂, 112a₃, 122a₁, 122a₂, and 122a3 all are in the range 0.5 to 100 L/(m²·h).

The nanofiltration membrane 112a can have lower water permeability than the water permeability of 112b. The nanofiltration membrane 122a can have a lower water permeability than the water permeability of the nanofiltration membrane 122b. In certain embodiments, the nanofiltration membrane 112a and/or 122a has a water permeability of 0.05 to 1.5 L/(m²·h·bar). In certain embodiments, the nanofiltration membrane 112a and/or 122a has a water permeability of 0.05, 0.1, 0.15, 0.2, 0.25, 0.3, 0.35, 0.4, 0.5, 0.6, 0.7, 0.8, 0.9, 1, 1.1, 1.2, 1.3, 1.4 or 1.5 L/(m²·h·bar) or any range or value therebetween. In certain embodiments, the nanofiltration membrane 112a and/or 122a has a water permeability of 0.05 to 1.5 L/(m²·h·bar); 0.05 to 1 L/(m²·h·bar); 0.05 to 0.8 L/(m²·h·bar); 0.05 to 0.5 L/(m²·h·bar); 0.1 to 1.5 L/(m²·h·bar); 0.1 to 1 L/(m²·h·bar); 0.1 to 0.8 L/(m²·h·bar); 0.1 to 0.5 L/(m²·h·bar); 0.2 to 1.5 L/(m²·h·bar); 0.2 to 1 L/(m²·h·bar); 0.2 to 0.8 L/(m²·h·bar); 0.2 to 0.5 L/(m²·h·bar); 0.3 to 1.5 L/(m²·h·bar); 0.3 to 1 L/(m²·h·bar); 0.3 to 0.8 L/(m²·h·bar); or 0.3 to 0.5 L/(m²·h·bar). As an illustrative non limiting example the water permeability of 112a₁, 112a₂, and 112a₃ and/or 122a₁, 122a₂, and 122a₃ are the same and are in the range 0.05 L/(m²·h·bar) to 1.5 L/(m²·h·bar). The water permeability of the different nanofiltration membranes of the plurality of the nanofiltration membranes 112a and/or 122a in system 100c and 100d can be the same or different. In another illustrative non limiting example, in the system 100c and 100d the water permeability of 112a₁ is the same as that of 112a₂, but is different from that of 112a₃, and/or the water permeability of 122a₁ is the same as that of 122a₂, but is different from that of 122a₃, where the water permeability of the membranes 112a₁, 112a₂, 112a₃, 122a₁, 122a₂, and 122a₃ all are in the range 0.05 L/(m²·h·bar) to 1.5 L/(m²·h·bar). In another illustrative non limiting example, in the system 100c and 100d the water permeability of 112a₁, 112a₂, and 112a₃ and/or 122a₁, 122a₂, and 122a₃ are different, where the water permeability of the membranes 112a₁, 112a₂, 112a₃, 122a₁, 122a₂, and 122a₃ all are in the range 0.05 L/(m²·h·bar) to 1.5 L/(m²·h·bar). Non-limiting examples of commercially available membranes that can be used as the membranes 112a and/or 122a includes CSM NE8040-90, CSM NE4040-90, CSM NE4040-90 from TORAY.

In certain embodiments, the nanofiltration membrane 112b and/or 122b has a salt permeability of >100 L/(m²·h) to 400 L/(m²·h). In certain embodiments, the nanofiltration membrane 112b and/or 122b has a salt permeability of >100, 150, 200, 250, 300, 350, or 400 L/(m²·h) or any value or range therebetween. In certain embodiments, the nanofiltration membrane 112b and/or 122b has a salt permeability of >100 to 400 L/(m²·h); >100 to 350 L/(m²·h); >100 to 300 L/(m²·h); >100 to 250 L/(m²·h); 150 to 400 L/(m²·h); 150 to 350 L/(m²·h); 150 to 300 L/(m²·h); 150 to 250 L/(m²·h); 200 to 400 L/(m²·h); 200 to 350 L/(m²·h); 200 to 300 L/(m²·h); or 200 to 250 L/(m²·h). The salt permeability of the different nanofiltration membranes of the plurality of the nanofiltration membranes 112b and/or 122b in system 100c and 100d can be the same or different. As an illustrative non limiting example the salt permeability of 112b₁, 112b₂, and 112b₃ and/or 122b₁, 122b₂, and 122b₃ (in the system 100c and 100d) are the same, and are in the range >100 L/(m²·h) to 400 L/(m²·h). In another illustrative non limiting example, in the system 100c and 100d the salt permeability of 112b₁ is the same as that of 112b₂, but is different from that of 112b₃, and/or 122b₁ is the same as that of 122b₂, but is different from that of 122b₃, where salt permeability of the membranes 112b₁, 112b₂, 112b₃, 122b₁, 122b₂, and 122b₃ all are in the range >100 L/(m²·h) to 400 L/(m²·h). In another illustrative non limiting example, in the system 100c and 100d the salt permeability of 112b₁, 112b₂, and 112b₃ and/or 122b₁, 122b₂, and 122b₃ are different, where salt permeability of the membranes 112b₁, 112b₂, 112b₃, 122b₁, 122b₂, and 122b₃, all are in the range >100 L/(m²·h) to 400 L/(m²·h).

In certain embodiments, the nanofiltration membrane 112b and/or 122b has a water permeability of >1.5 to 5 L/(m²·h·bar). In certain embodiments, the nanofiltration membrane 112b and/or 122b has a water permeability of >1.5, 2, 2.5, 3, 3.5, 4, 4.5 or 5 L/(m²·h·bar) or any range or value therebetween. In certain embodiments, the nanofiltration membrane 112b and/or 122b has a water permeability of >1.5 to 5 L/(m²·h·bar); >1.5 to 4 L/(m²·h·bar); >1.5 to 3.5 L/(m²·h·bar); >1.5 to 3 L/(m²·h·bar); 2 to 5 L/(m²·h·bar); 2 to 4 L/(m²·h·bar); 2 to 3.5 L/(m²·h·bar); 2 to 3 L/(m²·h·bar); 2.5 to 5 L/(m²·h·bar); 2.5 to 4 L/(m²·h·bar); 2.5 to 3.5 L/(m²·h·bar); or 2.5 to 3 L/(m²·h·bar). The water permeability of the different nanofiltration membranes of the plurality of the nanofiltration membranes 112b and/or 122b in system 100c and 100d can be the same or different. As an illustrative non limiting example the water permeability of 112b₁, 112b₂, and 112b₃ and/or 122b₁, 122b₂, and 122b₃ (in the system 100c and 100d) are the same, and are in the range >1.5 L/(m²·h·bar) to 5 L/(m²·h·bar). In another illustrative non-limiting example, in the system 100c and 100d the water permeability of 112b₁ is the same as that of 112b₂, but is different from that of 112b₃, and/or 122b₁ is the same as that of 122b₂, but is different from that of 122b₃, where the water permeability of the membranes 112b₁, 112b₂, 112b₃, 122b₁, 122b₂, and 122b₃ all are in the range >1.5 L/(m²·h·bar) to 5 L/(m²·h·bar). In another illustrative non limiting example, in the system 100c and 100d the water permeability of 112b₁, 112b₂, and 112b₃ and/or 122b₁, 122b₂, and 122b₃ are different, where the water permeability of the membranes 112b₁, 112b₂, 112b₃, 122b₁, 122b₂, and 122b₃ all are in the range >1.5 L/(m²·h·bar) to 5 L/(m²·h·bar). In the system 100c and 100d, the number of membranes 112a and/or 122a and the number of membranes 112b and/or 122b can be the same or different. Non-limiting examples of commercially available membranes that can be used as the membranes 112b includes DuPont-Filmtec NF-4040 from DUPONT.

In the system 100c and/or 100d, the number of membranes 112a and the number of membranes 122a can be the same or different. In the system 100c and/or 100d, the number of membranes 112b and the number of membranes 122b can be the same or different.

The saline solution 160 can be brackish water, marine water, saline industrial waste water, or any combination thereof. Brackish water can have a salt concentration of 5,000 to 30,000 ppm. Marine water can have a salt concentration of 30,000 ppm to 50,000 ppm. Saline industrial waste water can be an industrial waste water having a salt concentration of 5,000 ppm to 50,000 ppm. Salt contained in brackish water, marine water, saline industrial waste water, and brine can primarily be sodium chloride.

In certain embodiments, the aqueous solution 140 contains a brine solution. The brine solution can be a byproduct from a desalination process. In certain embodiments, the aqueous solution 140, in the system 100a-d, is flowed through the first feed inlet 111 at a flow rate of 1, 2, 3, 4, 5, 6, 7, 8, 9, 10, 11, 12, 13, 14, 15, 16, 17, 18, 19, 20, 21, 22, 23, 24, or 25 m³/h or any range or value therein. In certain embodiments, the aqueous solution 140, in the system 100a-d, is flowed through the first feed inlet 111 at a flow rate of 1 to 25 m³/h; 2 to 20 m³/h; 5 to 15 m³/h; 7.5 to 12.5 m³/h or any range or value therein. In certain embodiments, the aqueous solution 140 contains 70,000 to 90,000 mg/L total dissolved solids (TDS). In certain embodiments, the aqueous solution 140 contains 50,000 to 100,000 mg/L TDS; 60,000 to 90,000 mg/L TDS; 70,000 to 90,000 mg/L TDS; 70,000 to 85,000 mg/L TDS; 70,000 to 80,000 mg/L TDS; 75,000 to 85,000 mg/L TDS; or 75,000 to 80,000 mg/L TDS. In certain embodiments, the aqueous solution 140 contains 50,000, 55,000, 60,000, 65,000, 70,000, 71,000, 72,000, 73,000, 74,000, 75,000, 76,000, 77,000, 78,000, 79,000, 80,000, 81,000, 82,000, 83,000, 84,000, 85,000, 90,000, 95,000, or 100,000 mg/L TDS or any range or values therebetween.

In certain embodiments, the second concentrate 143, in the system 100a-d, is flowed through the reverse osmosis inlet 131 at a flow rate of 0.5, 1, 2, 3, 4, 5, 6, 7, 8, 9 or 10 m³/h or any range or value therein. In certain embodiments, the second concentrate 143 is flowed through the reverse osmosis inlet at a flow rate of 0.5 to 10 m³/h; 1 to 8 m³/h; 1 to 5 m³/h; 2 to 8 m³/h; 2 to 5 m³/h; or 2 to 3 m³/h. In certain embodiments, the second concentrate 143 contains 100,000 mg/L TDS to 140,000 mg/L TDS. In certain embodiments, the second concentrate 143 contains 100,000 mg/L TDS to 105,000 mg/L TDS, 100,000 mg/L TDS to 110,000 mg/L TDS, 100,000 mg/L TDS to 115,000 mg/L TDS, 100,000 mg/L TDS to 120,000 mg/L TDS, 100,000 mg/L TDS to 125,000 mg/L TDS, 100,000 mg/L TDS to 130,000 mg/L TDS, 100,000 mg/L TDS to 135,000 mg/L TDS, 100,000 mg/L TDS to 140,000 mg/L TDS, 105,000 mg/L TDS to 110,000 mg/L TDS, 105,000 mg/L TDS to 115,000 mg/L TDS, 105,000 mg/L TDS to 120,000 mg/L TDS, 105,000 mg/L TDS to 125,000 mg/L TDS, 105,000 mg/L TDS to 130,000 mg/L TDS, 105,000 mg/L TDS to 135,000 mg/L TDS, 105,000 mg/L TDS to 140,000 mg/L TDS, 110,000 mg/L TDS to 115,000 mg/L TDS, 110,000 mg/L TDS to 120,000 mg/L TDS, 110,000 mg/L TDS to 125,000 mg/L TDS, 110,000 mg/L TDS to 130,000 mg/L TDS, 110,000 mg/L TDS to 135,000 mg/L TDS, 110,000 mg/L TDS to 140,000 mg/L TDS, 115,000 mg/L TDS to 120,000 mg/L TDS, 115,000 mg/L TDS to 125,000 mg/L TDS, 115,000 mg/L TDS to 130,000 mg/L TDS, 115,000 mg/L TDS to 135,000 mg/L TDS, 115,000 mg/L TDS to 140,000 mg/L TDS, 120,000 mg/L TDS to 125,000 mg/L TDS, 120,000 mg/L TDS to 130,000 mg/L TDS, 120,000 mg/L TDS to 135,000 mg/L TDS, 120,000 mg/L TDS to 140,000 mg/L TDS, 125,000 mg/L TDS to 130,000 mg/L TDS, 125,000 mg/L TDS to 135,000 mg/L TDS, 125,000 mg/L TDS to 140,000 mg/L TDS, 130,000 mg/L TDS to 135,000 mg/L TDS, 130,000 mg/L TDS to 140,000 mg/L TDS, or 135,000 mg/L TDS to 140,000 mg/L TDS. In certain embodiments, the second concentrate 143 contains 100,000 mg/L TDS, 105,000 mg/L TDS, 110,000 mg/L TDS, 115,000 mg/L TDS, 120,000 mg/L TDS, 125,000 mg/L TDS, 130,000 mg/L TDS, 135,000 mg/L TDS, or 140,000 mg/L TDS. In certain embodiments, the second concentrate 143 contains at least 100,000 mg/L TDS, 105,000 mg/L TDS, 110,000 mg/L TDS, 115,000 mg/L TDS, 120,000 mg/L TDS, 125,000 mg/L TDS, 130,000 mg/L TDS, or 135,000 mg/L TDS.

In certain embodiments, the reverse osmosis concentrate 145 has a flow rate of 0.1 m³/h to 10 m³/h, 0.1 m³/h to 7.5 m³/h, 0.1 m³/h to 5 m³/h, 0.1 m³/h to 2.5 m³/h, 0.1 m³/h to 2 m³/h, 0.1 m³/h to 1.5 m³/h, 0.5 m³/h to 7.5 m³/h, 0.5 m³/h to 5 m³/h, 0.5 m³/h to 2.5 m³/h, 0.5 m³/h to 2 m³/h, or 0.5 m³/h to 1.5 m³/h. In certain embodiments, the reverse concentrate 145 has a flow rate of 0.1, 0.5, 0.6, 0.7, 0.8, 0.9, 1, 1.1, 1.2, 1.3, 1.4, 1.5, 2, 3, 4, 5, 6, 7, 8, 9 or 10 m³/h, or any value or range therebetween. In certain embodiments, the reverse osmosis concentrate 145 contains 160,000 to 200,000 mg/L TDS. In certain embodiments, the reverse osmosis concentrate 145 contains 150,000 mg/L TDS to 210,000 mg/L TDS. In certain embodiments, the reverse osmosis concentrate 145 contains 150,000 mg/L TDS to 155,000 mg/L TDS, 150,000 mg/L TDS to 160,000 mg/L TDS, 150,000 mg/L TDS to 165,000 mg/L TDS, 150,000 mg/L TDS to 170,000 mg/L TDS, 150,000 mg/L TDS to 175,000 mg/L TDS, 150,000 mg/L TDS to 180,000 mg/L TDS, 150,000 mg/L TDS to 185,000 mg/L TDS, 150,000 mg/L TDS to 190,000 mg/L TDS, 150,000 mg/L TDS to 195,000 mg/L TDS, 150,000 mg/L TDS to 200,000 mg/L TDS, 150,000 mg/L TDS to 210,000 mg/L TDS, 155,000 mg/L TDS to 160,000 mg/L TDS, 155,000 mg/L TDS to 165,000 mg/L TDS, 155,000 mg/L TDS to 170,000 mg/L TDS, 155,000 mg/L TDS to 175,000 mg/L TDS, 155,000 mg/L TDS to 180,000 mg/L TDS, 155,000 mg/L TDS to 185,000 mg/L TDS, 155,000 mg/L TDS to 190,000 mg/L TDS, 155,000 mg/L TDS to 195,000 mg/L TDS, 155,000 mg/L TDS to 200,000 mg/L TDS, 155,000 mg/L TDS to 210,000 mg/L TDS, 160,000 mg/L TDS to 165,000 mg/L TDS, 160,000 mg/L TDS to 170,000 mg/L TDS, 160,000 mg/L TDS to 175,000 mg/L TDS, 160,000 mg/L TDS to 180,000 mg/L TDS, 160,000 mg/L TDS to 185,000 mg/L TDS, 160,000 mg/L TDS to 190,000 mg/L TDS, 160,000 mg/L TDS to 195,000 mg/L TDS, 160,000 mg/L TDS to 200,000 mg/L TDS, 160,000 mg/L TDS to 210,000 mg/L TDS, 165,000 mg/L TDS to 170,000 mg/L TDS, 165,000 mg/L TDS to 175,000 mg/L TDS, 165,000 mg/L TDS to 180,000 mg/L TDS, 165,000 mg/L TDS to 185,000 mg/L TDS, 165,000 mg/L TDS to 190,000 mg/L TDS, 165,000 mg/L TDS to 195,000 mg/L TDS, 165,000 mg/L TDS to 200,000 mg/L TDS, 165,000 mg/L TDS to 210,000 mg/L TDS, 170,000 mg/L TDS to 175,000 mg/L TDS, 170,000 mg/L TDS to 180,000 mg/L TDS, 170,000 mg/L TDS to 185,000 mg/L TDS, 170,000 mg/L TDS to 190,000 mg/L TDS, 170,000 mg/L TDS to 195,000 mg/L TDS, 170,000 mg/L TDS to 200,000 mg/L TDS, 170,000 mg/L TDS to 210,000 mg/L TDS, 175,000 mg/L TDS to 180,000 mg/L TDS, 175,000 mg/L TDS to 185,000 mg/L TDS, 175,000 mg/L TDS to 190,000 mg/L TDS, 175,000 mg/L TDS to 195,000 mg/L TDS, 175,000 mg/L TDS to 200,000 mg/L TDS, 175,000 mg/L TDS to 210,000 mg/L TDS, 180,000 mg/L TDS to 185,000 mg/L TDS, 180,000 mg/L TDS to 190,000 mg/L TDS, 180,000 mg/L TDS to 195,000 mg/L TDS, 180,000 mg/L TDS to 200,000 mg/L TDS, 180,000 mg/L TDS to 210,000 mg/L TDS, 185,000 mg/L TDS to 190,000 mg/L TDS, 185,000 mg/L TDS to 195,000 mg/L TDS, 185,000 mg/L TDS to 200,000 mg/L TDS, 185,000 mg/L TDS to 210,000 mg/L TDS, 190,000 mg/L TDS to 195,000 mg/L TDS, 190,000 mg/L TDS to 200,000 mg/L TDS, 190,000 mg/L TDS to 210,000 mg/L TDS, 195,000 mg/L TDS to 200,000 mg/L TDS, 195,000 mg/L TDS to 210,000 mg/L TDS, or 200,000 mg/L TDS to 210,000 mg/L TDS. In certain embodiments, the reverse concentrate 145 contains 150,000 mg/L TDS, 155,000 mg/L TDS, 160,000 mg/L TDS, 165,000 mg/L TDS, 170,000 mg/L TDS, 175,000 mg/L TDS, 180,000 mg/L TDS, 185,000 mg/L TDS, 190,000 mg/L TDS, 195,000 mg/L TDS, 200,000 mg/L TDS, or 210,000 mg/L TDS. In certain embodiments, the reverse concentrate 145 contains at least 150,000 mg/L TDS, 155,000 mg/L TDS, 160,000 mg/L TDS, 165,000 mg/L TDS, 170,000 mg/L TDS, 175,000 mg/L TDS, 180,000 mg/L TDS, 185,000 mg/L TDS, 190,000 mg/L TDS, 195,000 mg/L TDS, or 200,000 mg/L TDS.

In certain embodiments, the aqueous solution 140 is nano filtered using the nanofiltration membrane(s) 112 (in system 100a)/112a (in system 100b)/112a (in system 100c, d) at a pressure of 20 to 60 bar; 25 bar to 50 bar; 25 to 45 bar; or 30 to 40 bar. In certain embodiments, the aqueous solution 140 is nano filtered using the nanofiltration membrane(s) 112 (in system 100a)/112a (in system 100b)/112a (in system 100c, d) at a pressure of 20, 25, 30, 31, 32, 33, 34, 35, 36, 37, 38, 39, 40, 45, 50, 55 or 60 bar, or any range or value therebetween. In certain embodiments, the first intermediate concentrate 147 is nano filtered using the nanofiltration membrane(s) 112b (in system 100b)/112b (in system 100c, d) at a pressure of 20 to 60 bar; 25 bar to 50 bar; 25 to 45 bar; or 30 to 40 bar. In certain embodiments, the first intermediate concentrate 147 is nano filtered using the nanofiltration membrane(s) 112b (in system 100b)/112b (in system 100c, d) at a pressure of 20, 25, 30, 31, 32, 33, 34, 35, 36, 37, 38, 39, 40, 45, 50, 55 or 60 bar, or any range or value therebetween.

In certain embodiments, the first concentrate 142 is nano filtered using the nanofiltration membrane(s) 122 (in system 100a)/122a (in system 100b)/122a (in system 100c, d) at a pressure of 20 to 60 bar; 25 bar to 50 bar; 25 to 45 bar; or 30 to 40 bar. In certain embodiments, the first concentrate 142 is nano filtered using the nanofiltration membrane(s) 122 (in system 100a)/122a (in system 100b)/122a (in system 100c, d) at a pressure of 20, 25, 30, 31, 32, 33, 34, 35, 36, 37, 38, 39, 40, 45, 50, 55 or 60 bar, or any range or value therebetween. In certain embodiments, the second intermediate concentrate 148 is nano filtered using the nanofiltration membrane(s) 122b (in system 100b)/122b (in system 100c, d) at a pressure of 20 to 60 bar; 25 bar to 50 bar; 25 to 45 bar; or 30 to 40 bar. In certain embodiments, the second intermediate concentrate 148 is nano filtered using the nanofiltration membrane(s) 122b (in system 100b)/122b (in system 100c, d) at a pressure of 20, 25, 30, 31, 32, 33, 34, 35, 36, 37, 38, 39, 40, 45, 50, 55 or 60 bar, or any range or value therebetween.

The reverse osmosis membrane 132 can be a osmotically assisted reverse osmosis membrane. In certain embodiments, the osmotically assisted reverse osmosis membrane can be a high rejection osmotically assisted reverse osmosis membrane. In certain embodiments, the reverse osmosis membrane 132 can contain a plurality of reverse osmosis membranes, such as a plurality of osmotically assisted reverse osmosis membranes, such as a plurality of high rejection osmotically assisted reverse osmosis membranes. In certain embodiments, reverse osmosis, such as osmotically assisted reverse osmosis of the second concentrate 143 is performed using the membrane 132 (in system 100a-d) at a pressure of 60 to 85 bar; 65 bar to 80 bar; 70 to 80 bar; or 75 to 80 bar. In certain embodiments, reverse osmosis, such as osmotically assisted reverse osmosis of the second concentrate is performed using the membrane 132 (in system 100a-d) at a pressure of 60, 65, 70, 71, 72, 73, 74, 75, 76, 77, 78, 79, 80, or 85, bar, or any range or value therebetween.

In certain embodiments, the reverse osmosis membrane 132, such as the high rejection osmotically assisted reverse osmosis membrane has a water permeability of 0.05, 0.1, 0.15, 0.2, 0.25, 0.3, 0.35, 0.4, 0.5, 0.6, 0.7, 0.8, 0.9, 1, 1.1, 1.2, 1.3, 1.4, 1.5, 2, 2.5 or 3 L/(m²·h·bar) or any range or value therebetween. In certain embodiments the reverse osmosis membrane 132, such as the high rejection osmotically assisted reverse osmosis membrane has a water permeability of 0.05 to 3 L/(m²·h·bar); 0.05 to 2.5 L/(m²·h·bar); 0.05 to 2 L/(m²·h·bar); 0.05 to 1.5 L/(m²·h·bar); 0.05 to 1 L/(m²·h·bar); 0.05 to 0.8 L/(m²·h·bar); 0.05 to 0.6 L/(m²·h·bar); 0.1 to 3 L/(m²·h·bar); 0.1 to 2.5 L/(m²·h·bar); 0.1 to 2 L/(m²·h·bar); 0.1 to 1.5 L/(m²·h·bar); 0.1 to 1 L/(m²·h·bar); 0.1 to 0.8 L/(m²·h·bar); 0.1 to 0.6 L/(m²·h·bar); 0.2 to 3 L/(m²·h·bar); 0.2 to 2.5 L/(m²·h·bar); 0.2 to 2 L/(m²·h·bar); 0.2 to 1.5 L/(m²·h·bar); 0.2 to 1 L/(m²·h·bar); 0.2 to 0.8 L/(m²·h·bar); 0.2 to 0.6 L/(m²·h·bar); 0.3 to 3 L/(m²·h·bar); 0.3 to 2.5 L/(m²·h·bar); 0.3 to 2 L/(m²·h·bar); 0.3 to 1.5 L/(m²·h·bar); 0.3 to 1 L/(m²·h·bar); 0.3 to 0.8 L/(m²·h·bar); 0.3 to 0.6 L/(m²·h·bar); 0.4 to 3 L/(m²·h·bar); 0.4 to 2.5 L/(m²·h·bar); 0.4 to 2 L/(m²·h·bar); 0.4 to 1.5 L/(m²·h·bar); 0.4 to 1 L/(m²·h·bar); 0.4 to 0.8 L/(m²·h·bar); 0.4 to 0.6 L/(m²·h·bar); 0.5 to 3 L/(m²·h·bar); 0.5 to 2.5 L/(m²·h·bar); 0.5 to 2 L/(m²·h·bar); 0.5 to 1.5 L/(m²·h·bar); 0.5 to 1 L/(m²·h·bar); 0.5 to 0.8 L/(m²·h·bar); or 0.5 to 0.6 L/(m²·h·bar).

In certain embodiments, the reverse osmosis membrane 132, such as the high rejection osmotically assisted reverse osmosis membrane has a salt permeability of 0.5, 1, 2, 3, 4, 5, 6, 7, 8, 9, 10, 11, 12, 13, 14, 15, 20, 25 or 30 L/(m²·h) or any range or value therebetween. In certain embodiments the reverse osmosis membrane 132, such as the high rejection osmotically assisted reverse osmosis membrane has a salt permeability of 0.5 to 30 L/(m²·h); 0.5 to 25 L/(m²·h); 0.5 to 20 L/(m²·h); 0.5 to 15 L/(m²·h); 0.5 to 12 L/(m²·h); 0.5 to 10 L/(m²·h); 1 to 30 L/(m²·h); 1 to 25 L/(m²·h); 1 to 20 L/(m²·h); 1 to 15 L/(m²·h); 1 to 12 L/(m²·h); 1 to 10 L/(m²·h); 3 to 30 L/(m²·h); 3 to 25 L/(m²·h); 3 to 20 L/(m²·h); 3 to 15 L/(m²·h); 3 to 12 L/(m²·h); 3 to 10 L/(m²·h); 3 to 30 L/(m²·h); 3 to 25 L/(m²·h); 3 to 20 L/(m²·h); 3 to 15 L/(m²·h); 3 to 12 L/(m²·h); 3 to 10 L/(m²·h); 5 to 30 L/(m²·h); 5 to 25 L/(m²·h); 5 to 20 L/(m²·h); 5 to 15 L/(m²·h); 5 to 12 L/(m²·h); 5 to 10 L/(m²·h); 7 to 30 L/(m²·h); 7 to 25 L/(m²·h); 7 to 20 L/(m²·h); 7 to 15 L/(m²·h); 7 to 12 L/(m²·h); 7 to 10 L/(m²·h); 9 to 30 L/(m²·h); 9 to 25 L/(m²·h); 9 to 20 L/(m²·h); 9 to 15 L/(m²·h); 9 to 12 L/(m²·h); or 9 to 10 L/(m²·h).

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

### Example

A simulation model was developed using a system containing a first nanofiltration unit, a second nanofiltration unit, and a osmotically assisted reverse osmosis unit. The first nanofiltration unit included a plurality of first high rejection nanofiltration membranes and a plurality of first low rejection membranes. The first high rejection nanofiltration membranes had a salt permeability of 3.9 L/(m²·h) and a water permeability of 0.4 L/(m²·h·bar). The first low rejection nanofiltration membranes had a salt permeability of 230 L/(m²·h) and a water permeability of 2.7 L/(m²·h·bar). The second nanofiltration unit included a plurality of second high rejection nanofiltration membranes and a plurality of second low rejection membranes. The second high rejection nanofiltration membranes had a salt permeability of 3.9 L/(m²·h) and a water permeability of 0.4 L/(m²·h·bar). The second low rejection nanofiltration membranes had a salt permeability of 230 L/(m²·h) and a water permeability of 2.7 L/(m²·h·bar). The osmotically assisted reverse osmosis unit included a plurality of high rejection osmotically assisted reverse osmosis membranes. The high rejection osmotically assisted reverse osmosis membranes had a salt permeability of 9.2 L/(m²·h) and a water permeability of 0.57 L/(m²·h·bar). A brine solution having a concentration of 78,000 mg/L TDS was flowed into the first nanofiltration unit at a flow rate of 10 m³/h. The brine solution was nanofiltered using the first high rejection and first low rejection nanofiltration membranes at 35 bar to produce a first retentate. The first retentate was further nanofiltered using the second high rejection and second low rejection nanofiltration membranes at 35 bar to produce a second retentate. The second retentate had a concentration of 110,000 mg/L TDS. The second retentate was flowed into the osmotically assisted reverse osmosis unit at a flow rate of 2.7 m³/h. Osmotically assisted reverse osmosis of the second retentate was performed using the plurality of high rejection osmotically assisted reverse osmosis membranes at 73-75 bar to produce a reverse osmosis retentate having a concentration of 181,000 mg/L TDS. The reverse osmosis retentate had a flow rate of 1 m³/h.

1. A system for concentrating dissolved solids in an aqueous solution, the system comprising:
a first nanofiltration unit comprising a first nanofiltration membrane, a first feed inlet in fluid communication with an aqueous solution source comprising a brine, a first concentrate outlet, and a first permeate outlet;
a second nanofiltration unit comprising a second nanofiltration membrane, a second feed inlet in fluid communication with the first concentrate outlet, a second concentrate outlet, and a second permeate outlet; and
a reverse osmosis unit comprising a reverse osmosis membrane, a reverse osmosis feed inlet in fluid communication with the second concentrate outlet, a reverse osmosis concentrate outlet, and a reverse osmosis permeate outlet.

2. The system of claim 1, wherein the second permeate outlet is in fluid communication with the aqueous solution source.

3. The system of claim 1, wherein the reverse osmosis unit is an osmotically assisted reverse osmosis unit.

4. The system of claim 1, wherein the system further comprises a high pressure pump in fluid communication with the second concentrate outlet and the reverse osmosis feed inlet.

5. The system of claim 1, wherein the first nanofiltration unit comprises more than one nanofiltration membranes.

6. The system of claim 5, wherein a first of the one of the more than one nanofiltration membranes of the first nanofiltration unit has a lower water and salt permeability than a second of the more than one nanofiltration membranes of the first nanofiltration unit.

7. The system of claim 6, wherein the first of the more than one nanofiltration membranes of the first nanofiltration unit is in fluid communication with the first feed inlet and a first inter nanofiltration unit outlet and the second of the more than one nanofiltration membranes of the first nanofiltration unit is in fluid communication with the first inter nanofiltration unit outlet and the first concentrate outlet.

8. The system of claim 6, wherein the first of the more than one nanofiltration membranes of the first nanofiltration unit has a salt permeability of 0.5 L/(m²h) to 100 L/(m²h) and a water permeability of 0.05 L/(m²·h·bar) to 1.5 L/(m²·h·bar), and the second of the more than one nanofiltration membranes of the first nanofiltration unit has a salt permeability of greater than 100 L/(m²h) to 400 L/(m²h) and a water permeability of greater than 1.5 L/(m²·h·bar) to 5 L/(m²·h·bar).

9. The system of claim 1, wherein the second nanofiltration membrane comprises more than one nanofiltration membranes.

10. The system of claim 9, wherein a first of the more than one nanofiltration membranes of the second nanofiltration unit has a lower water and salt permeability than a second of the more than one nanofiltration membranes of the second nanofiltration unit.

11. The system of claim 10, wherein the first of the more than one nanofiltration membranes of the second nanofiltration unit is in fluid communication with the second feed inlet and a second inter nanofiltration unit outlet and the second of the more than one nanofiltration membranes of the second nanofiltration unit is in fluid communication with the second inter nanofiltration unit outlet and the second concentrate outlet.

12. The system of claim 10, wherein the first of the more than one nanofiltration membranes of the second nanofiltration unit has a salt permeability of 0.5 L/(m²h) to 100 L/(m²h) and a water permeability of 0.05 L/(m²·h·bar) to 1.5 L/(m²·h·bar), and the second of the more than one nanofiltration membranes of the second nanofiltration unit has a salt permeability of greater than 100 L/(m²h) to 400 L/(m²h) and a water permeability of greater than 1.5 L/(m²·h·bar) to 5 L/(m²·h·bar).

13. The system of claim 1, wherein the reverse osmosis membrane is a high rejection osmotically assisted reverse osmosis membrane having a salt permeability of 0.5 to 30 L/(m²·h) and a water permeability of 0.05 to 3 L/(m²·h·bar).

14. The system of claim 1, wherein the first nanofiltration unit is configured to be operated at a pressure of 25 to 45 bar.

15. The system of claim 1, wherein the second nanofiltration unit is configured to be operated at a pressure of 25 to 45 bar.

16. The system of claim 1, wherein the reverse osmosis unit is configured to be operated at a pressure of 65 to 80 bar.

17. A method for concentrating dissolved solids in an aqueous solution source using the system of claim 1, the method comprising the steps of:
flowing a brine through the first feed inlet to separate ions from the brine to form a first concentrate and a first permeate;
flowing the first concentrate through the second feed inlet to separate ions from the first concentrate to form a second concentrate and a section permeate; and
flowing the second concentrate through the reverse osmosis feed inlet to separate ions from the second concentrate to form a reverse osmosis concentrate and a reverse osmosis permeate.

18. The method of claim 17, wherein the brine comprises 70,000 to 90,000 mg/L total dissolved solids (TDS).

19. The method of claim 17, wherein the second concentrate comprises 100,000 to 140,000 mg/L TDS.

20. The method of claim 17, wherein the reverse osmosis concentrate comprises 160,000 to 200,000 mg/L TDS.
